(19) United States
(12) Patent Application Publication
(10) Pub. No.: US 2025/0040499 A1
(43) Pub. Date: Feb. 6, 2025

(54) A PROCESS AND SYSTEM FOR LINE PRODUCING SEED FILLED PLANT GROWTH MEDIUM POTS, RODS, OR BANDS

(71) Applicant: Ellepot A/S, Esbjerg N (DK)

(72) Inventors: Peter Meldgaard Jacobsen, Tjæreborg (DK); Mads Drachmann, Esbjerg V (DK)

(21) Appl. No.: 18/714,937

(22) PCT Filed: Dec. 5, 2022
(86) PCT No.: PCT/EP2022/084430

§ 371 Date: May 30, 2024

(30) Foreign Application Priority Data
Dec. 10, 2021 (DK) PA202101179

(51) Int. Cl. A01G 31/04

(52) U.S. Cl. CPC A01G 31/042

(57) ABSTRACT

A process for the line production of seed filled plant growth medium pots, rods, or bands, is provided. Specific seed filled plant growth medium pots, rods, or bands are also provided for use in the process. A continuous line of growth medium is prepared and seeded. The growth medium is then placed within hydroponic reservoirs. Seeding before separation of the growth medium means there is more control over placement of the seed(s) in a larger mass and more freedom to control and handle the subsequently formed seed filled plant growth medium pot, rod, or band.

### TECHNICAL FIELD OF THE INVENTION

The present invention relates to the production of growth medium pots, rods, or bands.

### BACKGROUND OF THE INVENTION

For the seed propagation of plants, it is well-known in the art to use small pots. The pots are traditionally made in a continuous process as disclosed in WO9203914 to obtain a cheap product that is relatively easy to handle. When the continuous blocks of growth medium are cut into pots/pieces of suitable size, each individual piece of the continuous block of growth medium is manually or automatically positioned into a propagation tray. An example of an automatic system is the Ellepot Multiflex, where a distributor with an X-Y movement mechanism distributes the individual pieces of the continuous block of growth medium into a propagation tray. Once the growth medium pot is positioned in the propagation tray, seeds are placed in the growth medium pots as the propagation tray passes a seed delivery unit. This system has the disadvantage that it is locked to specific models and sizes of propagation trays, making it difficult to use the same system for varying productions.

### DESCRIPTION OF THE INVENTION

It is an object of the present invention to provide a more versatile system suitable for varying productions.

A first aspect relates to a process for line producing seed filled plant growth medium pots, rods, or bands, comprising the steps of:
i) producing a continuous length of growth medium with a first side face, a second side face located opposite to said first side face, and a first end face;
iia) placing one or more seeds on or within said first end face; and
iiia) separating a part of the continuous length of growth medium comprising one or more seeds to form a seed filled plant growth medium pot, rod, or band, and a new first face of said continuous length of growth medium; and
iva) repeating the steps iia) and iiia) one or more times; or
iib) placing one or more seeds on or within said first and/or second side face(s);
iiib) separating a part of the continuous length of growth medium comprising one or more seeds to form a seed filled plant growth medium pot, rod, or band; and
ivb) repeating the steps iib) and iiib) one or more times; or
iic) separating a part of the continuous length of growth medium to form a plant growth medium pot, rod, or band, each with a first side face, a second side face located opposite to said first side face, a first end face, and a second end face; and
iiic) placing one or more seeds on or within said first and/or second end faces and/or placing one or more seeds on or within said first and/or second side faces to form a seed filled plant growth medium pot, rod, or band; and
ivc) repeating the steps iic) and iiic) one or more times.

The term “continuous length of growth medium” refers to the production of growth medium, which is made in a continuous line as e.g., disclosed in WO9203914, or by producing lengths of e.g., stone wool (see e.g., WO12172186) or other types of growth medium from, respectively, a block of stone wool or a block of another type of growth medium and sorting them end-by-end to form a continuously growing length of growth medium. The length of growth medium is thereafter cut into pieces of suitable size (height relative to the diameter), corresponding to the desired size of growth medium pots, rods, or bands.

The advantage of seeding before the separation of a part of the continuous length of growth medium is that there is much more control over the placement of the seed(s) in a larger mass and more freedom to control and handle the subsequently formed seed filled plant growth medium pot, rod, or band. Depending on the type and use of the seed filled plant growth medium pot, rod, or band, the seed may be placed at different positions and/or in different patterns on or in the plant growth medium pot, rod, or band. When placing one or more seeds on or within the end face (the free end) of the continuous length of growth medium, it is e.g., possible to produce seed filled plant growth medium pots of varying heights. When placing one or more seeds on or within the first and/or second side face(s) of the continuous length of growth medium, it is e.g., possible to produce special seed filled plant growth medium pots, rods, or bands of varying lengths that are especially suitable for hydroponic production.

Alternatively, it is possible to seed after the separation of a part of the continuous length of growth medium. One advantage of this procedure is that it is possible to place a seed at either both or one of the first or second end faces of a formed (i.e., separated, e.g., cut) pot, rod, or band during a movement towards a distributor unit.

Hence, in general, the seed filled plant growth medium pots, rods, or bands may be produced as standing versions (i.e., standing on an end face) or lying versions (i.e., lying on a side face, preferably on a side face that has not been seeded).

When the seed filled plant growth medium pots, rods, or bands is produced as lying versions, the length of the growth medium pot, rod, or band is preferably at least 0.5 meters. Shorter lengths of 0.1-0.4 meters, are contemplated by the present invention, but less preferred. Compared to a traditional growth medium pot, which have a bottom end and a top end, this type of growth medium rod is configured with a front end and a rear end as its length requires it to lie down, e.g., within the cavity of the hydroponic reservoir. If produced as a growth medium covered by a suitable paper, this configuration reduces the area of growth medium, which is not covered by the sheet material and thereby reduces the risk of growth medium clogging the hydroponic system's filters, pumps, and tubing recirculating the nutrient solution. The length of the growth medium pot, rod, or band may preferably for hydroponic production be within the range of 0.5-20 meters, such as within the range of 1-18 meters, e.g. within the range of 2-16 meters, such as within the range of 3-14 meters, e.g. within the range of 4-15 meters, such as within the range of 5-14 meters, and even more preferably within the range of 5-10 meters.

In one or more embodiments, the process further comprises the steps of:
iv) providing an elongated hydroponic reservoir with one or more spaces each adapted for receiving a seed filled plant growth medium pot, rod, or band; and
v) positioning said plant growth medium pot(s), rod(s), or band(s) within said space.

In one or more embodiments, the process comprises the steps of:
iib) placing one or more seeds on or within said first and/or second side face(s);
iiib) separating a part of the continuous length of growth medium comprising one or more seeds to form a seed filled plant growth medium pot, rod, or band; and
ivb) repeating the steps iib) and iiib) one or more times.

In one or more embodiments, the process comprises the steps of:
ib) drilling or indenting a plurality of cavities along the length of said first and/or second side face(s);
iib) placing one or more seeds into said plurality of cavities;
iiib) separating a part of the continuous length of growth medium comprising one or more seeds to form a seed filled plant growth medium pot, rod, or band; and
ivb) repeating the steps ib), iib), and iiib) one or more times.

In one or more embodiments, step iib) comprises placing one or more seeds at multiple sites and at a predefined distance therebetween along the length of said first and/or second side face(s). This embodiment enables the production of multiple plants in each seed filled plant growth medium pot, rod, or band. This could e.g., be advantageous for hydroponic production of e.g., lettuce. Furthermore, the same process allows for line production of different lengths of seed filled plant growth medium pots, rods, or bands in the same run.

In one or more embodiments, the process comprises the steps of:
iia) placing one or more seeds on or within said first end face; and
iiia) separating a part of the continuous length of growth medium comprising one or more seeds to form a seed filled plant growth medium pot, rod, or band, and a new first face of said continuous length of growth medium; and
iva) repeating the steps iia) and iiia) one or more times.

In one or more embodiments, the process comprises the steps of:
ia) drilling or indenting one or more cavities within said first end face, e.g., through the side face and into the end face;
iia) placing one or more seeds within said one or more cavities; and
iiia) separating a part of the continuous length of growth medium comprising one or more seeds to form a seed filled plant growth medium pot, rod, or band, and a new first face of said continuous length of growth medium; and
iva) repeating the steps ia), iia), and iiia) one or more times.

In one or more embodiments, the process comprises the steps of:
iic) separating a part of the continuous length of growth medium to form a plant growth medium pot, rod, or band, each with a first side face, a second side face located opposite to said first side face, a first end face, and a second end face; and
iiic) placing one or more seeds on or within said first and/or second end faces and/or placing one or more seeds on or within said first and/or second side faces to form a seed filled plant growth medium pot, rod, or band; and
ivc) repeating the steps iic) and iiic) one or more times.

In one or more embodiments, the process comprises the steps of:
ic) drilling or indenting a plurality of cavities along the length of said first and/or second side face(s);
iic) separating a part of the continuous length of growth medium to form a plant growth medium pot, rod, or band, each with a first side face, a second side face located opposite to said first side face, a first end face, and a second end face; and
iiic) placing one or more seeds within said cavities to form a seed filled plant growth medium pot, rod, or band; and
ivc) repeating the steps ic), iic), and iiic) one or more times.

In one or more embodiments, the process comprises the steps of:
iic1) separating a part of the continuous length of growth medium to form a plant growth medium pot, rod, or band, each with a first side face, a second side face located opposite to said first side face, a first end face, and a second end face;
iic2) drilling or indenting a plurality of cavities within the first and/or second end face;
iiic) placing one or more seeds within said cavities to form a seed filled plant growth medium pot, rod, or band; and
ivc) repeating the steps iic1), iic2), and iiic) one or more times.

A second aspect relates to a seed filled plant growth medium pot, rod, or band produced by the process according to the present invention.

A third aspect relates to a system for use in a process of producing a seed filled plant growth medium pot, rod, or band, comprising:
an apparatus adapted for producing a continuous length of growth medium with a first side face, a second side face located opposite to said first side face, and a first end face;
a seed delivery unit adapted for placing, e.g., positioning or dropping, one or more seeds:
a) on or within said first end face; and/or
b) on or within said first and/or second side face(s); and
an apparatus adapted for separating a part of the continuous length of growth medium comprising one or more seeds, thereby forming a seed filled plant growth medium pot, rod, or band.

In one or more embodiments, the system further comprises:
at least one of a drilling unit and indentation unit,
wherein the drilling unit is adapted for drilling one or more cavities:
i) within said first end face; and/or
ii) within said first and/or second side face(s);
wherein the indentation unit is adapted for indenting one or more cavities:
i) within said first end face; and/or
ii) within said first and/or second side face(s).

A fourth aspect relates to a system for use in a process of line producing a seed filled plant growth medium pot, rod, or band, comprising:
an apparatus adapted for producing a continuous length of growth medium with a first side face, a second side face located opposite to said first side face, and a first end face;
an apparatus adapted for separating a part of the continuous length of growth medium, thereby forming a plant growth medium pot, rod, or band with a first side face, a second side face located opposite to said first side face, a first end face, and a second end face; and
a seed delivery unit adapted for placing, e.g., positioning or dropping, one or more seeds on or within said first and/or second end faces of said plant growth medium pot, rod, or band and/or placing, e.g., positioning or dropping, one or more seeds on or within said first and/or second side faces of said plant growth medium pot, rod, or band, to form a seed filled plant growth medium pot, rod, or band.

The apparatus adapted for producing a continuous length of growth medium may be as disclosed in WO1992003914 or WO19011742, hereby incorporated by reference. In some embodiments, the main difference is that the length of the rod may be substantially longer than the traditionally produced pot. In this case, a fewer number of separations (e.g., cuts) per time period is obviously needed.

The apparatus adapted for separating a part of the continuous length of growth medium may e.g., comprise a knife, a saw, a hotwire, or the like, preferably configured to be reciprocating. Such means are also described in WO1992003914 and WO19011742.

The seed delivery unit may be adapted for positioning or dropping a seed into a formed cavity in said plant growth medium pot, rod, or band, and may e.g., comprise a distributor adapted for positioning or dropping a seed into a formed cavity in the plant growth medium pot, rod, or band. In some embodiments, the seed delivery unit may be seeding equipment known within the art and may e.g., be a drumseeder, needleseeder, transplanter, or the like.

In one or more embodiments, the above-mentioned system(s) further comprises a distributor unit adapted for positioning said seed filled plant growth medium pot(s), rod(s), or band(s) into an elongated hydroponic reservoir, or into a propagation tray, or into a storage or transport tray, or onto a storage or transport reel, or the like.

The distributor unit may in some embodiments be of any type known within the art being configured for distributing, and optionally also incorporating the apparatus adapted for producing a continuous length of growth medium, optionally in the form of growth medium held in a water and air permeable sheet material. Suitable types of distributor units may be as disclosed in WO2017216146, WO2017216145, or WO19001944, hereby incorporated by reference.

In one or more embodiments, the elongated hydroponic reservoir is a tube, pipe, or gutter. The length of the elongated hydroponic reservoir may vary, but is preferably at least 2 meters long, such as within the range of 2-50 meters, e.g. at least 3 meters, such as within the range of 3-45 meters, e.g. at least 4 meters, such as within the range of 4-40 meters, e.g. at least 5 meters, such as within the range of 5-35 meters, e.g. at least 6 meters, such as within the range of 6-30 meters, e.g. at least 7 meters, such as within the range of 7-25 meters, e.g. at least 8 meters, such as within the range of 8-20 meters, e.g. at least 9 meters, such as within the range of 9-15 meters, e.g. at least 10 meters.

The distributor unit may in some embodiments e.g., comprise:
a plurality of distributor elements configured to move between a loading position and an unloading position; each distributor element comprising an open-ended channel or cavity adapted for receiving a whole number of seed filled plant growth medium pots; wherein the distributor elements, in a loading position, are positioned relatively to each other such that their open-ended channels or cavities are disposed in continuation to each other to form a receiving unit with an open-ended channel or cavity adapted for receiving a single length of seed filled plant growth medium pots; and wherein the distributor elements, when in an unloading position, are rotated, relative to their loading position, such that their open-ended channels or cavities are disposed parallel relative to each other. Such a type of distributor unit may also be configured to prepare a separated plant growth medium pot to be seeded, where the seed is placed when the distributor element is in its unloading position. Thereby, the seeding and unloading operations are performed simultaneously or at least sequentially. The distributor unit may further comprise a piston unit adapted for entering the open-ended channel or cavity of a distributor element when in the unloading position, thereby releasing the seed filled plant growth medium pot therefrom. This configuration secures that the plant growth medium pot leaves the open-ended channel or cavity at the right time. The piston of the piston unit may be provided with a channel adapted for transporting and directing one or more seeds to the plant growth medium pot. In this way, the piston unit has a dual role as part of both the seed delivery unit and the distributor unit.

Alternatively, the distributor unit may be configured as a rod or band guide adapted for directing the seed filled plant growth medium rod(s), or band(s) into an elongated hydroponic reservoir, or into a propagation tray, or into a storage or transport tray, or onto a storage or transport reel, or the like. The rod or band guide may be configured with openings adapted for allowing the seed delivery unit to operate through the rod or band guide to place one or more seeds along the length of the plant growth medium rod(s), or band(s) passing therethrough.

In one or more embodiments, the above-mentioned system(s) further comprises a conveyor system adapted for transporting an elongated hydroponic reservoir through said distributor unit.

The seed delivery unit may be integrated into the distributor unit, e.g., thereby allowing the seed positioning process and the distribution process to be performed simultaneously.

In one or more embodiments, the above-mentioned system(s) further comprises at least one of a drilling unit and indentation/dibbling unit. The drilling unit and the indentation unit may be present in the same system. In this situation, the system further comprises a controller configured for activating either the drilling unit or the indentation unit. The drilling unit is adapted for drilling a cavity in the plant growth medium pot, rod, or band. The drilling unit may e.g., comprise a column drill and optionally means adapted for removing the by the drill removed growth medium. The indentation unit is adapted for indenting a cavity in the plant growth medium pot, rod, or band and may comprise a dibble tool, preferably comprising means adapted for penetrating the rod's sheet material, if present. If a rod or band guide is present, the drilling unit and indentation/dibbling unit may be configured to operate through the rod or band guide to form cavities along the length of the plant growth medium rod(s), or band(s) passing therethrough. The distance between the cavities depends on the type of plant to be grown, but could e.g., be within the range of 3-30 cm, such as within the range of 4-25 cm, preferably within the range of 5-20 cm, e.g., within the range of 10-15 cm. The cavity is adapted for receiving one or more seeds.

In one or more embodiments, the cavities are distributed at equidistance along the length of the plant growth medium rod, or band.

As used in the specification and the appended claims, the singular forms “a”, “an”, and “the” include plural referents unless the context clearly dictates otherwise.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIGS. 1 and 3 show different views of system parts for line production of seed filled plant growth medium pots, rods, or bands according to various embodiments of the present invention.

FIGS. 2A-C show examples of a continuous length of growth medium as well as a plant growth medium rod.

### DETAILED EMBODIMENTS OF THE INVENTION

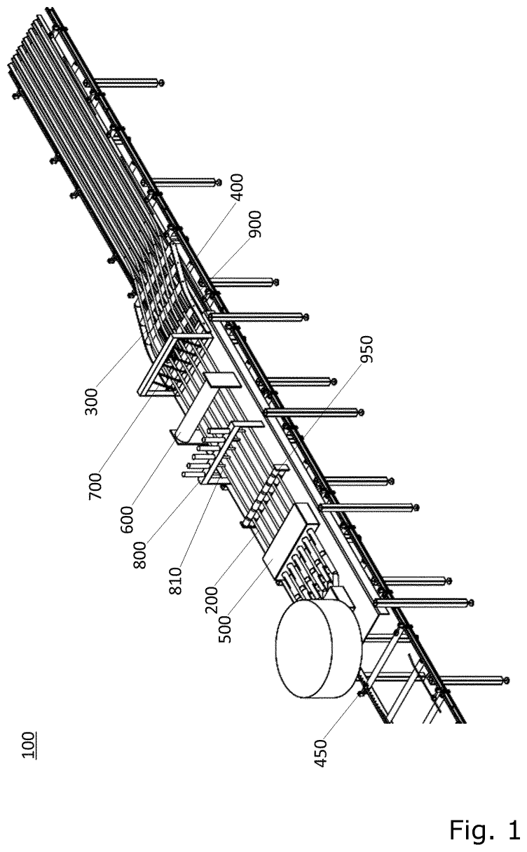

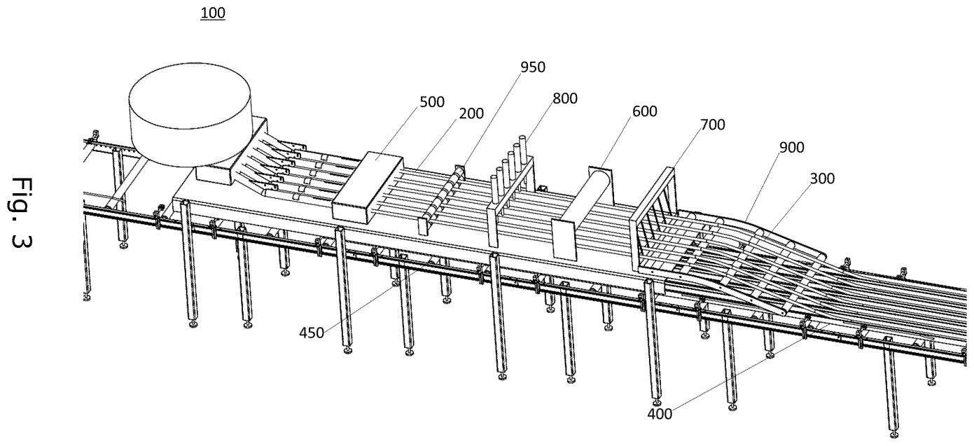

FIGS. 1 and 3 show different views of a system 100 for line production of seed filled plant growth medium rods 300. The system 100 comprises an apparatus 500 adapted for producing a continuous length of growth medium 200. The shape of the growth medium rods 300 may vary, such as square rods, cylindrical rods, or rectangular rods, but are here shown as cylindrical rods. After the shaping of the growth medium 200, the continuous length of growth medium 200 is prepared for seeding, by the drilling unit 800 that comprises a drill 810 adapted for forming a cavity for the seed to be positioned in. Alternatively, an indentation unit may be used (not shown). After passing the drilling unit 800, the continuous length of growth medium 200 is seeded by a seed delivery unit 600, here embodied as a drumseeder. The continuous length of growth medium 200 is now ready for separation into seed filled plant growth medium rods 300. This operation is performed by an apparatus 700, here embodied with reciprocating knifes. Finally, the seed filled plant growth medium rods 300 enters a distributor unit 900 that positions individual seed filled plant growth medium rods 300 within elongated hydroponic reservoirs 400. A conveyor system 450 transports the hydroponic reservoirs 400 from a position below the drilling unit 800 and the seed delivery unit 600, to a position below the distributor unit 900. A forwarding mechanism, here embodied as a pair of feed rolls 950, aids in the process of supporting and forwarding the continuous length of growth medium 200 through the system 100.

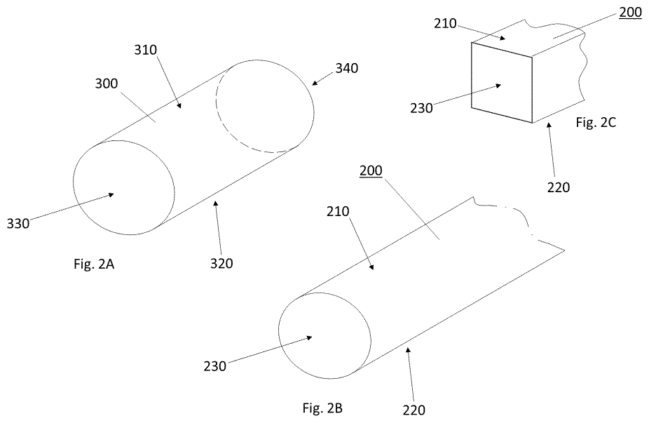

FIGS. 2B-C show examples of a continuous length of growth medium 200 with a first end face (only the free end with the end face is shown). The continuous length of growth medium 200 is embodied as a square rod in FIG. 2C and a cylindrical rod in FIG. 2B. Both rods are shown with a first side face 210, a second side face 220 located opposite to the first side face 210, and a first end face 230. The squared rod, obviously, has two further side faces.

FIG. 2A shows an example of a cylindrical growth medium rod 300 with first 330 and second 340 end faces and cut from a continuous length of growth medium 200 as shown in FIG. 2B.

### REFERENCES

100 System
200 Continuous length of growth medium
210 First side face
220 Second side face
230 First end face
300 Plant growth medium rod
330 First end face
340 Second end face
400 Hydroponic reservoir
450 Conveyor
500 Apparatus
600 Seed delivery unit
700 Apparatus
800 Drilling unit
810 Drill
900 Distributor unit
950 Pair of feed rolls

1. A process for line producing seed filled plant growth medium, rods, comprising the steps of:
i) producing a continuous length of growth medium with a first side face, a second side face located opposite to said first side face, and a first end face;
iia) placing one or more seeds on or within said first end face; and
iiia) separating a part of the continuous length of growth medium comprising one or more seeds to form a seed filled plant growth medium rod, and a new first face of said continuous length of growth medium; and
iva) repeating the steps iia) and iiia) one or more times; or
iib) placing one or more seeds on or within said first and/or second side face(s);
iiib) separating a part of the continuous length of growth medium comprising one or more seeds to form a seed filled plant growth medium rod; and
ivb) repeating the steps iib) and iiib) one or more times; or
iic) separating a part of the continuous length of growth medium to form a plant growth medium rod, each with a first side face, a second side face located opposite to said first side face, a first end face, and a second end face; and
iiic) placing one or more seeds on or within said first and/or second end faces and/or placing one or more seeds on or within said first and/or second side faces to form a seed filled plant growth medium rod; and
ivc) repeating the steps iic) and iiic) one or more times;
iv) providing an elongated hydroponic reservoir with one or more spaces each adapted for receiving a seed filled plant growth medium rod; and
v) positioning said plant growth medium rod(s) within said space.

2. (canceled)

3. The process according to claim 1, comprising the steps of:
iib) placing one or more seeds on or within said first and/or second side face(s);
iiib) separating a part of the continuous length of growth medium comprising one or more seeds to form a seed filled plant growth medium rod; and
ivb) repeating the steps iib) and iiib) one or more times.

4. The process according to claim 3, wherein step iib) comprises placing one or more seeds at multiple sites and at a predefined distance therebetween along the length of said first and/or second side face(s).

5. The process according to claim 1, comprising the steps of
iic) separating a part of the continuous length of growth medium to form a plant growth medium rod, each with a first side face, a second side face located opposite to said first side face, a first end face, and a second end face; and
iiic) placing one or more seeds on or within said first and/or second end faces and/or placing one or more seeds on or within said first and/or second side faces to form a seed filled plant growth medium rod; and
ivc) repeating the steps iic) and iiic) one or more times.

6. (canceled)

7. A system for use in a process of producing a seed filled plant growth medium rod, comprising:
an apparatus adapted for producing a continuous length of growth medium with a first side face, a second side face located opposite to said first side face, and a first end face;
a seed delivery unit adapted for placing, e.g., positioning or dropping, one or more seeds:
a) on or within said first end face; and/or
b) on or within said first and/or second side face(s); and
an apparatus adapted for separating a part of the continuous length of growth medium comprising one or more seeds, thereby forming a seed filled plant growth medium rod.

8. The system according to claim 7, further comprising:
at least one of a drilling unit and indentation unit,
wherein the drilling unit is adapted for drilling one or more cavities:
i) within said first end face; and/or
ii) within said first and/or second side face(s);
wherein the indentation unit is adapted for indenting one or more cavities:
i) within said first end face; and/or
ii) within said first and/or second side face(s).

9. A system for use in a process of line producing a seed filled plant growth medium rod, comprising:
an apparatus adapted for producing a continuous length of growth medium with a first side face, a second side face located opposite to said first side face, and a first end face;
an apparatus adapted for separating a part of the continuous length of growth medium, thereby forming a plant growth medium rod with a first side face, a second side face located opposite to said first side face, a first end face, and a second end face; and
a seed delivery unit adapted for placing, e.g., positioning or dropping, one or more seeds on or within said first and/or second end faces of said plant growth medium rod and/or placing, e.g., positioning or dropping, one or more seeds on or within said first and/or second side faces of said plant growth medium rod, to form a seed filled plant growth medium rod.

10. The system according to claim 7, further comprising:
a distributor unit adapted for positioning said seed filled plant growth medium rod into an elongated hydroponic reservoir.

11. The system according to claim 10, further comprising a conveyor system adapted for transporting an elongated hydroponic reservoir through said distributor unit.

12. The system according to claims 10, wherein said seed delivery unit is integrated into said distributor unit, e.g., thereby allowing the seed positioning process and the distribution process to be performed simultaneously.

13. The system according to claim 7, further comprising:
a distributor unit adapted for positioning said seed filled plant growth medium rod into an elongated hydroponic reservoir.

14. The system according to claim 13, further comprising a conveyor system adapted for transporting an elongated hydroponic reservoir through said distributor unit.

15. The system according claim 7, wherein the length of the formed growth medium rod is within the range of 0.5-20 meters.

16. The process according to claim 1, wherein the length of the formed growth medium rod is within the range of 0.5-20 meters.
